(19) United States
(12) Patent Application Publication
(10) Pub. No.: US 2015/0355534 A1
(43) Pub. Date: Dec. 10, 2015

(54) Light Directing Device and Method of Use

(71) Applicant: Geoff McCue, Lawrence, KS (US)

(72) Inventor: Geoff McCue, Lawrence, KS (US)

(21) Appl. No.: 14/295,382

(22) Filed: Jun. 4, 2014

(51) Int. Cl. G03B 21/20; G02B 26/04

(52) U.S. Cl. CPC G03B 21/206; G02B 26/04

(57) ABSTRACT

The light directing device of the present invention is comprised generally of a housing unit with at least one orifice, a light source inside the housing unit, at least one movable shield, a means for controlling the movable shield(s), and a means for controlling the light source. Also disclosed is a method of directing light wherein the movable shields are selectively moved to block one or more of the orifices in the housing unit and the light is passed from the light source through the orifices not blocked by the movable shield and projecting the passed light onto a surface that projects an image. In an alternative embodiment, the passed light is onto a medium that produces an image.

### FIELD

The present invention relates to the field of light directing devices. More specifically, the present invention relates to a light directing device used for light projection or light imaging.

### BACKGROUND

Light-based imaging and projecting systems, such as Digital Light Processors (DLP) or Digital Mirror Devices (DMD), have been used in a variety of operations in order to digitally control light. Applications of such systems include imaging a printing plate, pad or screen; selectively curing light sensitive materials or coatings; and projection of images. A DLP or DMD uses a micro mirror chip in which there are a plurality of mirrors that can be digitally addressed to affect the direction of light. While these devices and methods for light imaging and projection are effective and provide a high resolution output, the chips are susceptible to heat, dust, electronic failure and must be used with an optical lens component.

Another disadvantage of the DLP system occurs when it is used in the graphic arts to make plates or screens. When a light is projected from the DLP through a lens and onto the photographic substrate, there is accompanying “halo” of light that falls around the perimeter of the imaging spot that may be detrimental to highly sensitive materials or fine resolution images. Additionally, if any of the mirrors on the chip become dirty, fogged or fails to rotate in the correct position, then the light is blocked or misdirected, which compromises the integrity of the image. While light or illumination sources used will vary by device and application, when standard ultraviolet (UV) lamps or high intensity lights are used there is a significant amount of heat generated. Either a liquid cooling or cooling fans must dissipate the heat. Liquid cooling adds cost and increases maintenance factors. Cooling fans are not as effective as liquid cooling and can also contribute to the dust and fogging on the mirrors and optics components. Finally, moving parts, such as focusing or alignment components are typically placed around the light imaging or projecting device, which contributes to dirt, dust and other influences on imaging quality.

In light of these limitations, it would therefore be useful to have a device to control and/or direct light that does not require the use of micro mirror chips, has minimal moving parts and provides high-resolution output.

### BRIEF SUMMARY OF THE INVENTION

It is the object of the present invention to address several challenges in the previous attempts to control and/or direct light using DLP or DMD devices. The light directing device of the present invention is comprised generally of a housing unit with at least one orifice, a light source inside the housing unit, at least one movable shield, a means for controlling the movable shield(s), and a means for controlling the light source. Also disclosed is a method of directing light wherein the movable shields are selectively moved to block one or more of the orifices in the housing unit and the light is passed from the light source through the orifices not blocked by the movable shield and projecting the passed light onto a surface that projects an image. In an alternative embodiment, the passed light is onto a medium that produces an image.

### BRIEF DESCRIPTION OF THE DRAWINGS

FIG. 1. FIG. 1 is a perspective view of an exemplary embodiment of the light directing device of the present invention.

FIG. 2. FIG. 2 is cross-sectional side view of an exemplary embodiment of the light directing device of the present invention.

FIG. 3. FIG. 3 is a cross-sectional front view of an exemplary embodiment of the light directing device of the present invention.

FIG. 4. FIG. 4 is a cross-sectional front view of an alternative embodiment of the light directing device of the present invention.

### DETAILED DESCRIPTION

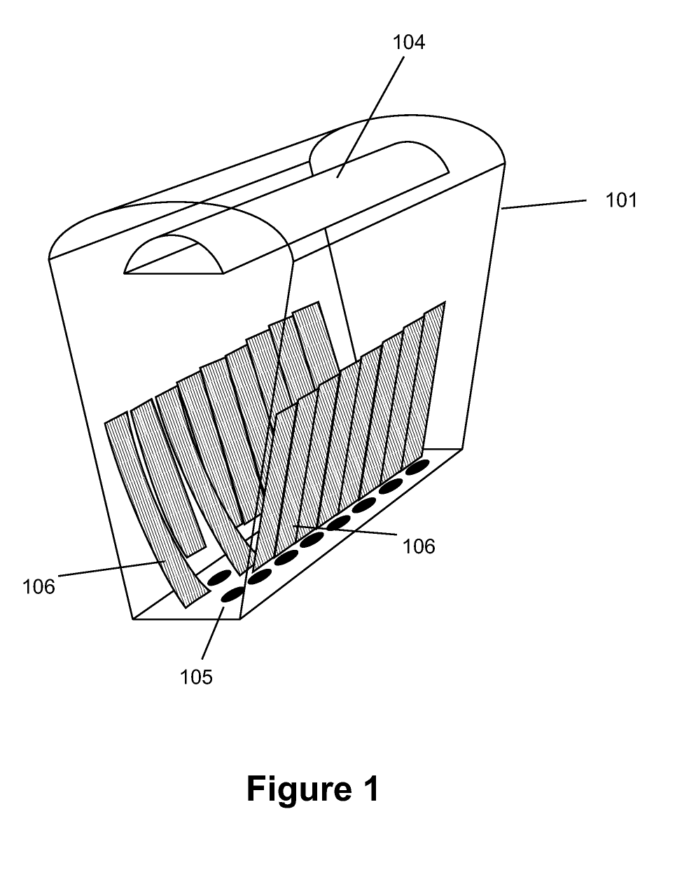

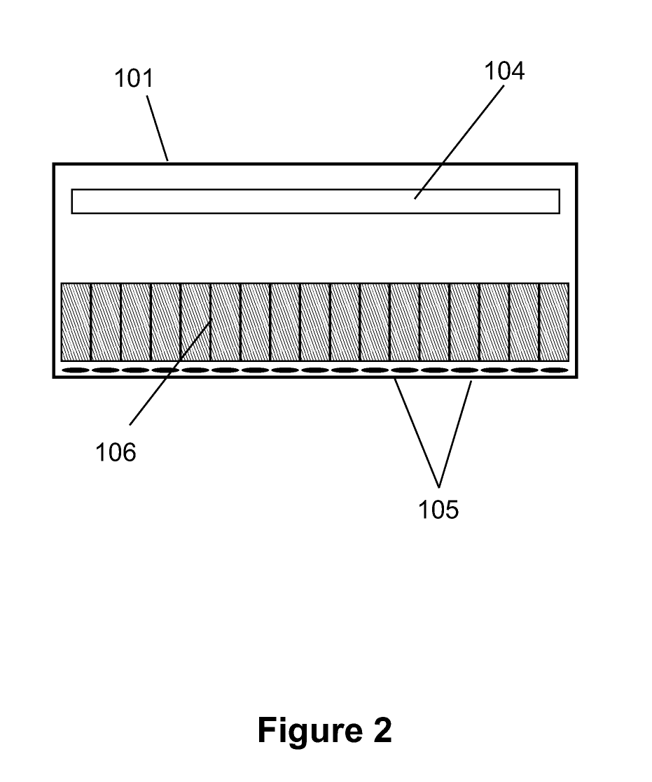

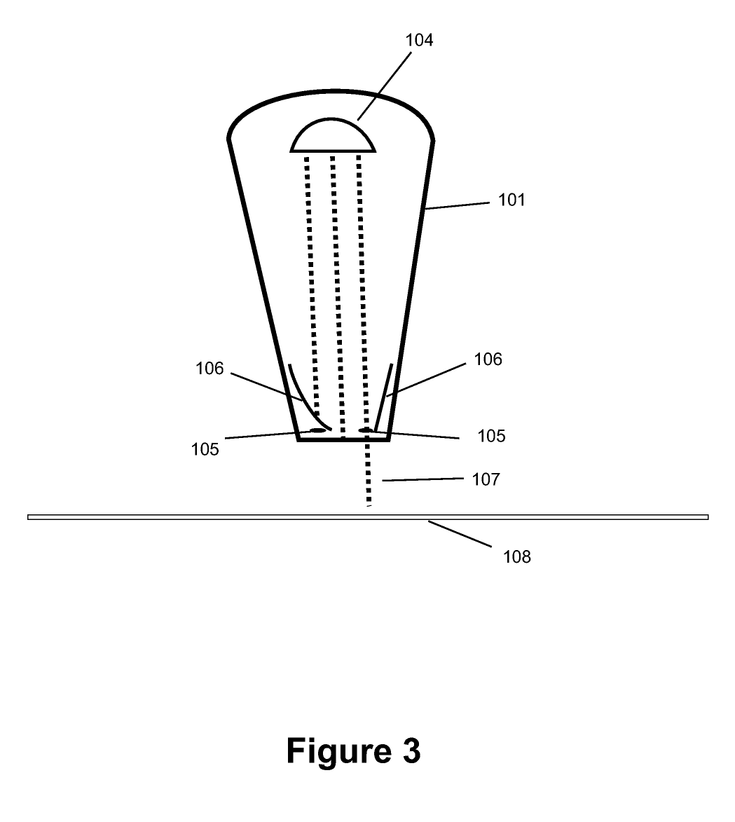

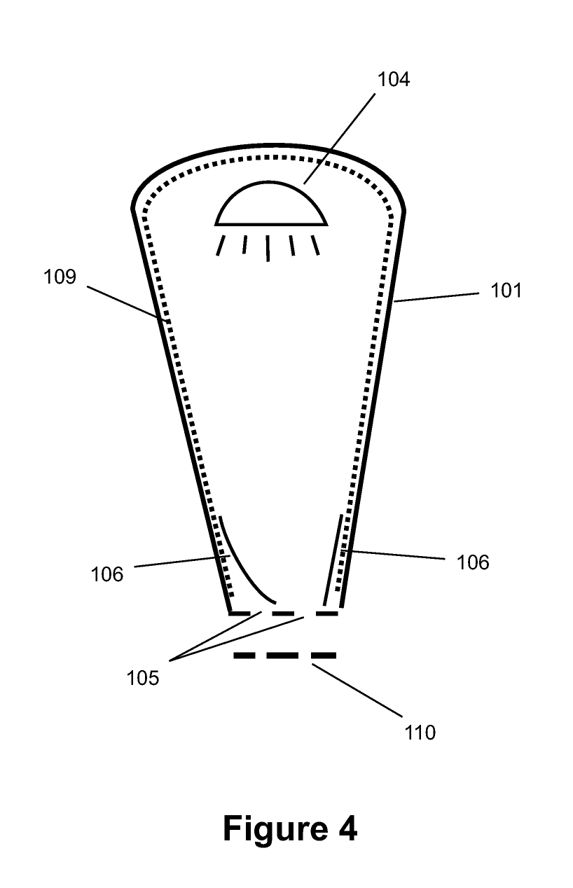

Turning to FIGS. 1-3, an exemplary embodiment of the light directing device of the present invention is shown. The light directing device has a housing unit 101 having an outer side wall, an inner side wall; a proximal end and a distal end. The housing unit includes at lease one orifice 105. The housing unit 101 may be made of any suitable material, including but not limited to plastic, metal, glass or combinations thereof. The orifice 105 may be located at any point along the housing unit 101, including along the side walls, but in the exemplary embodiment shown in FIG. 1 the orifices 105 are located at the distal end of the housing unit 101. The orifices 105 may be arranged in at least one straight line (as shown in FIGS. 1-4), circular, elliptical or half elliptical arrangements. The orifices 105 may be fixed to the housing 101 or may be detachable my means of an orifice plate 110 to allow for size, resolution and speed distinctions, shown in further detail in FIG. 4. The orifice plate 110 may be of varying thickness with various orifice 105 patterns, such as straight line, circular, elliptical or half elliptical.

The light directing device also has a light source 104 located inside the housing unit. In the exemplary embodiment the light source is located at the proximal end of the housing unit 101 and opposite the orifices 105. The light source 104 may include a UV lamp, high intensity lamp, metal halide lamp, a laser, a fluorescent lamp, a light-emitting device (LED), an x-ray device, a non-visible light device or any combination thereof This design allows the light source 104 to be interchangeable for added versatility of use. A light directional cover, such as a Fresnel lens, may be used to cover the light source 104 in order to direct the light in a singular direction through the orifices 105. The light directing device has at least one moveable shield 106, which can be moved into position to selectively block the orifices 105 such that the light source 104 sends passed light 107 through one or more orifices 105 and projects and image onto surface 108. Alternatively, the passed light 107 may be projected onto a medium that produces an image. Examples of such mediums include a projection screen, a wall, a background, a stage or a non-visible light receptor.

The moveable shields 106 are engaged by a means for controlling the moveable shield. An electric signal or electronic signal may be used as the means for controlling the movable shield. For example, the movable shields 106 can be activated utilizing digitally addressed piezoelectric components, micro electro mechanical systems (MEMS) or electromechanical components. It is understood that an apparatus, such as a computer, may be used to send the signal used to control the moveable shields. The moveable shields 106 may be attached to one or more sides of the inner walls of the housing unit and may be made from a variety of materials, including plastic, metal, glass and the like.

As shown in FIG. 4, in an alternative embodiment of the light directing device, the housing 101 may have a lining 109 covering the inner wall in order to direct all light from the light source 104 to the orifice(s) 105. The lining 109 may be made of a variety of materials that are reflective, non-reflective or light absorbing. Examples of such materials include a flat, mirrored lining, a dimpled, mirrored lining, a flat black colored lining, a lead or other metal lining.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the method (and components of the individual operating components of the method) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections might be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A light directing device, comprising:
a) a housing unit, having an outer side wall, an inner side wall; a proximal end, and a distal end, wherein the housing unit includes at least one orifice and;
b) a light source, being inside of the housing unit;
c) at least one movable shield, being inside and near the distal end of the housing unit;
d) a means for controlling at least one movable shield.
e) a means for controlling the light source

2. The light directing device of claim 1 wherein at least one orifice in the housing unit is near the distal end.

3. The light directing device of claim 1 wherein at least one orifice in the housing unit is along the side walls.

4. The light directing device of claim 1 wherein at least one orifice in the housing unit is fixed to the housing or is detachable by means of an orifice plate.

5. The light directing device of claim 1 wherein the at least one movable shield selectively blocks at least one orifice in the housing unit by engaging the means for controlling at least one movable shields.

6. The light directing device of claim 1 further comprising a covering lining the inner wall of the housing unit wherein the covering material is selected from the group comprising of a reflective material, a non-reflective material, a light absorbing material or combinations thereof.

7. The light directing device of claim 1, wherein the means for controlling at least one movable shield is an electric signal or electronic signal.

8. The light directing device of claim 7 wherein the movable shield comprises at least one piezoelectric component.

9. The light directing device of claim 7 wherein the movable shield comprises at least one MEMS component.

10. The light directing device of claim 7 wherein the movable shield comprises at least one electromechanical component.

11. The light directing device of claim 1, wherein the housing unit material is selected from the group comprising plastic, metal, glass or combinations thereof.

12. The light directing device of claim 1, wherein the light source is selected from the group comprising a UV lamp, a high intensity lamp, a metal halide lamp, a laser, a fluorescent lamp, a light-emitting device (LED), an x-ray device, a non-visible light device, or a combinations thereof.

13. The light directing device of claim 1, wherein at least one movable shield is attached to one or more sides of the inner walls of the housing unit.

14. The light directing device of claim 1, wherein the orifices in the housing unit are in at least one straight line, circular, half circular, elliptical or half elliptical arrangement.

15. The light directing device of claim 1, wherein the device projects an image,

16. The light directing device of claim 1, where in the device produces an image with light.

17. A method of directing light, comprising:
a) passing light from a light source inside a light directing device, wherein the light directing device comprises a housing unit having an outer wall, an inner wall; a proximal end, and a distal end, wherein the proximal end includes the light source and the distal end includes at least one orifice; at least one movable shield, being inside and near the distal end of the housing unit; and a means for controlling at least one movable shield.
b) selectively moving the movable shields using the means for controlling the movable shields in order to block one or more of the orifices in the housing unit;
c) allowing light from the light source to pass through the orifices in the housing unit that are not blocked by the movable shield; and
d) projecting the passed light onto a surface that projects an image.

18. The method of projecting an image of claim 15, wherein at least one movable shield is moved with an electric or electronic signal.

19. The method of claim 15, wherein the housing unit further comprises a covering lining the inner wall of the housing unit wherein the covering material is selected from the group comprising of a reflective material, a non-reflective material, a light absorbing material or combinations thereof.

20. A method of directing light, comprising:
a) passing light from a light source inside a light directing device, wherein the light directing device comprises a housing unit having an outer wall, an inner wall; a proximal end, and a distal end, wherein the proximal end includes the light source and the distal end includes at least one orifice; at least one movable shield, being inside and near the distal end of the housing unit; and a means for controlling at least one movable shield.
b) selectively moving the movable shields using the means for controlling the movable shields in order to block one or more of the orifices in the housing unit;
c) allowing light from the light source to pass through the orifices in the housing unit that are not blocked by the movable shield; and
d) projecting the passed light onto a medium that projects an image
